(19) United States
(12) Patent Application Publication
(10) Pub. No.: US 2010/0272873 A1
(43) Pub. Date: Oct. 28, 2010

(54) PASTEURIZED SWIMMING CRAB BACK FIN

(76) Inventor: John David Paterson, Toronto (CA)

Correspondence Address: GOTTLIEB RACKMAN & REISMAN PC, 270 MADISON AVENUE, 8TH FLOOR, NEW YORK, NY, 10016-0601, US

(21) Appl. No.: 12/765,468

(22) Filed: Apr. 22, 2010

Related U.S. Application Data
(60) Provisional application No. 61/171,902, filed on Apr. 23, 2009.

(51) Int. Cl. A23L 1/33; A23L 1/01; B65B 55/14; A23B 4/00

(52) U.S. Cl. 426/393; 426/479; 426/397; 426/418

(57) ABSTRACT

The present invention is directed to a method and system for preparing a pasteurized swimming crab back (PSCB) fin leg (“crab leg”) for individual consumption. In particular, the method and system of the present invention results in a pasteurized, hand-held, all natural food product for consumption by a consumer. The PSCB product is a ready to eat crab leg that has been trimmed, cleaned, thermo processed and packed in a hermetically sealed can or cup.

This patent application claims priority from U.S. provisional patent application Ser. No. 61/171,902 filed on Apr. 23, 2009.

### BACKGROUND OF THE INVENTION

Pasteurized crabmeat cannot easily compete with the canapé foods that are easy to consume, such as shrimp cocktail, buffalo wings etc. Normally, crabmeat is buried in a crab cake or a pasta etc, and is otherwise strictly a “fork food”. It would be desirable therefore to enable a crab to be eaten casually with one's hands, and to otherwise give it greater presentation appeal.

### SUMMARY OF THE INVENTION

The present invention is directed to a method and system for preparing a pasteurized swimming crab back (PSCB) fin leg (“crab leg”) for individual consumption. In particular, the method and system of the present invention results in a pasteurized, hand-held, all natural food product for consumption by a consumer. The PSCB product is a ready to eat crab leg that has been trimmed, cleaned, thermo processed and packed in a hermitically sealed can or cup.

Accordingly, it is an object of the invention to provide an improved method for preparing a pasteurized swimming crab back fin leg for individual consumption.

Another object of the invention is to provide a crab leg product that has been trimmed, cleaned, processed and packed.

A further object of the invention is to provide a method for converting the jumbo lump portion or body meat of a crab into a finger food.

Still another object of the invention is to provide a pasteurized crab meat product that can be eaten out of the can.

Still other objects of the invention will be apparent from the following description.

### BRIEF DESCRIPTION OF THE DRAWINGS

FIG. 1 is a top plan view and depicts a live crab, complete with all legs and body intact;

FIG. 2 is a top plan view and depicts a de-backed crab with jumbo lump portions attached to swimming legs and also showing remaining leg sections separated from one another with connected meat portions;

FIG. 3 is a top plan view and depicts a crab after being de-backed, particularly showing jumbo lumps connected to swimming legs; and

FIG. 4 is a photograph of the complete ready-to-eat product.

### DETAILED DESCRIPTION OF THE INVENTION

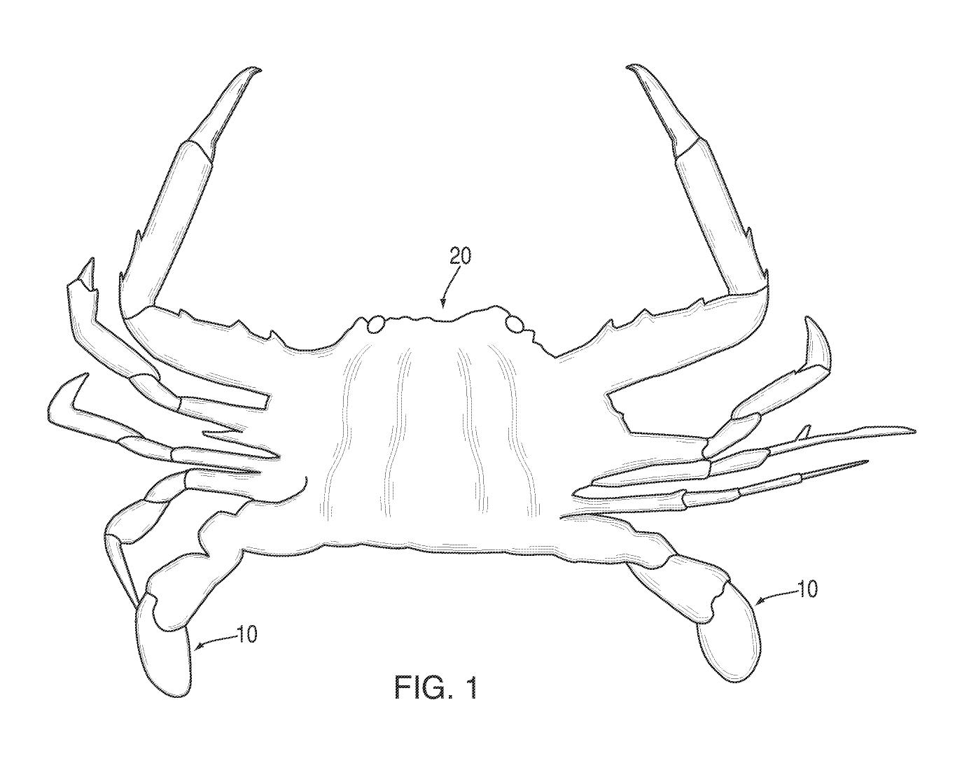

A crab, and preferably a live blue swimming back fin crab is shown in FIG. 1, including swimming legs 10 and back 20. In the method of the present invention, each such crab is steam cooked for a range of from 20 to 35 minutes and preferably for 35 minutes. Each cooked crab is air cooled using strong fans in a room ambient temperature environment for a period of 2 hours to lower the internal temperature of the crab. Cooled crabs are bagged and inserted into baskets and then transferred to a cold storage unit for overnight chilling. When cooled in the cold storage unit, the temperature is maintained in the range of 1 to 4° C. for at least an eight hour period, so that the internal temperature of the crab is reduced to the range of 1 to 10° C.

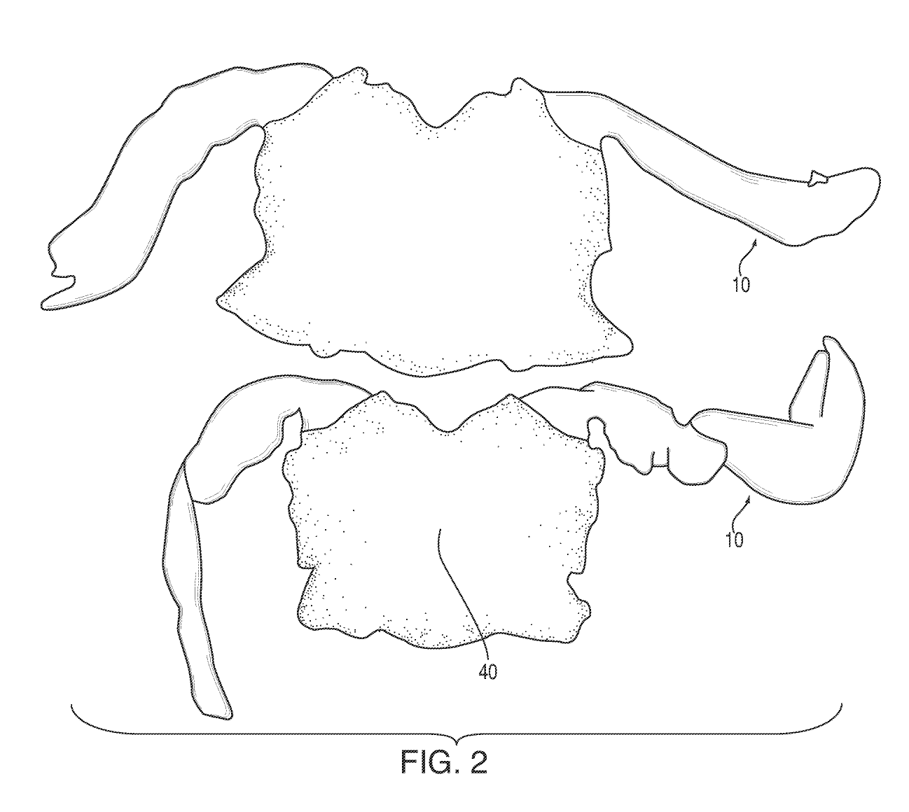

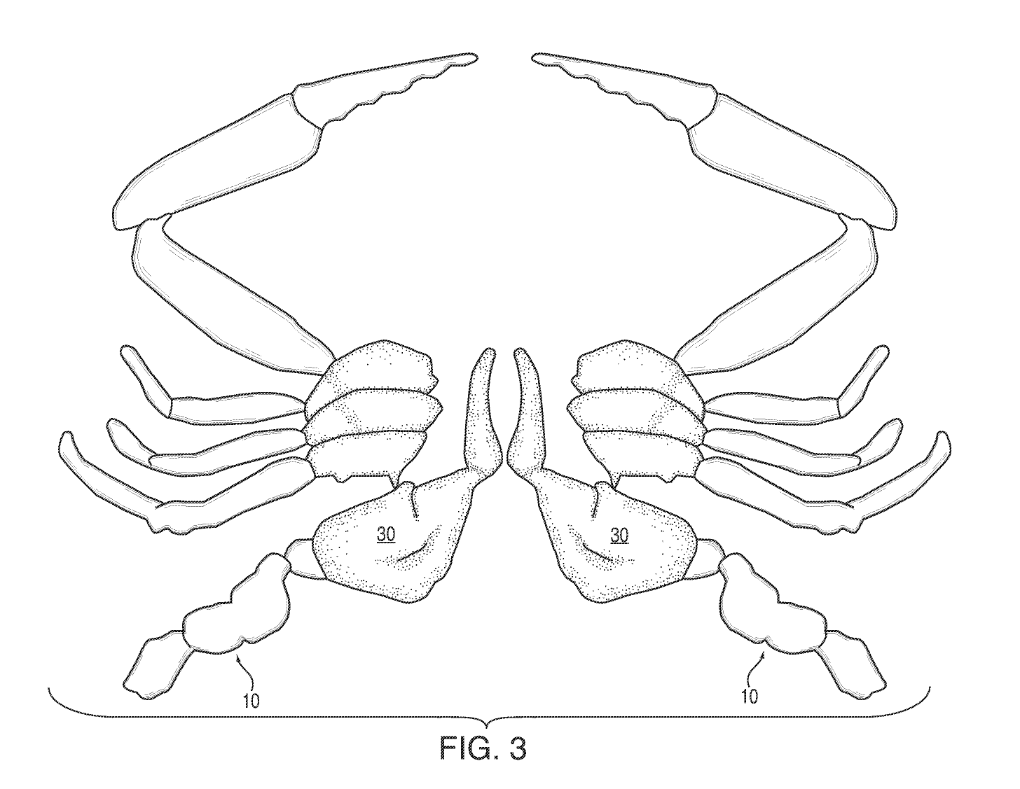

Once the internal temperature of the crab is lowered to the range of 1 to 10° C., the crab is then de-backed. When de-backed, the carapaces, the gills, and fat are removed. Any remaining soft shell and residual fat are also removed. FIG. 2 shows the de-backed crab with its two legs 10 remaining attached. Once the crab is de-backed, the remaining pleopod, that is the body meat (the “jumbo lump”) 40 remains attached to the swimming legs, or pleopod, which still contains the claw or leg meat within the pleopod shell. As can be seen in FIG. 2, debacked crabs have swimming legs attached, but otherwise all other shell has been removed. The legs are then sectioned, with a portion of the jumbo lump remaining attached to each leg. FIG. 3 shows the de-backed legs sectioned, wherein each section includes swimming leg 10 and jumbo lump portion 30. Each section is a ready-to-eat crab leg and is comprised of a shelled crab leg and a jumbo lump portion. The jumbo lump may then be manually trimmed, a process commonly known as “manicuring,” by removing any remaining outer shell remnants surrounding the jumbo lump and cleaning any residual fat. A large membrane, which attaches the claw shell to the jumbo lump, remains intact. The debacked crabs are then split into two parts with roughly half the meat remaining with each swimming leg element. Then each split crab element is put in plastic bags and packed in ice such that the exterior temperature remains in the range of −2° C. to +2° C. This range is selected so as to reduce the risk of meat decomposition. The soft shell of the swimming leg of each split crab element is then scored from its top to just above the fin.

In some cases, the processing may result in broken fins or small quantities of meat. Those legs with broken fins, broken or mushy meat, or below a threshold weight (such as ten grams) are removed from the population and discarded.

The bagged split crab elements are then delivered to a sizing line for purposes of sizing the products. Different sized products are placed in correspondingly sized trays, wherein each tray is packed in ice. Each split crab element is then inserted into a metal can and hermetically sealed to undergo further thermo processing. In general, the quantities per can may vary with size of can and weight of crab legs. For example, “Jumbo Crab Cicles” could contain 21-25 pieces of up to 10 gram size and “Colossal Crab Cicles” could contain 15-20 pieces of greater than 10 gram size.

The crab leg is then pasteurized as follows. The hermetically sealed cans are placed in baskets and the baskets are submerged into hot water tanks. The pasteurization process can then begin, which includes heating the cans to a temperature range of 85-88° C. for a time period of 135-160 minutes.

For either thermo process, heat penetration tests must be run to determine the killing lethality of the process and the associated shelf life. The target value is assurance of a product shelf life of at least 18 months, with such assurance based upon traditional water bath heat penetration tests for a defined time period. Upon completion of the heating cycle, the baskets are transferred to an ice slurry bath and submerged for a range of 90 to 145 minutes. The ice slurry is agitated throughout the time period. The overall pasteurization process follows FDA guidelines to assure that all pathogens are eliminated. The cans are then removed from the ice slurry bath, dried off, labeled as needed, and placed in master cartons for delivery to cold storage.

By following this process, the intended shelf life for the product is 18 months.

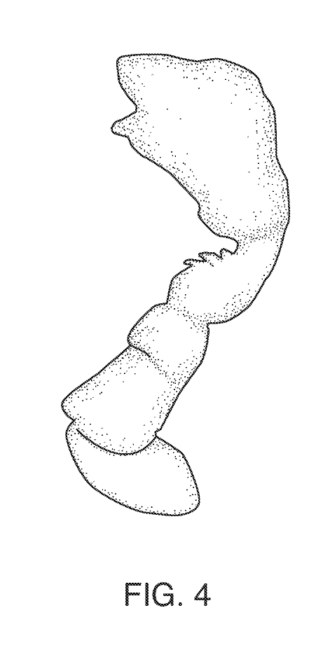

Once a can is opened, each crab leg is a hand-held ready to eat product and may, for example, be dipped into cocktail or tartar sauce. FIG. 4 shows a completed ready-to-eat product.

The scope of the invention will now be set forth in the following claims.

1. A method for preparing a crab back fin leg comprising:
cooking a crab, the crab including a body meat portion and a pair of legs;
after cooking, cooling the crab in order to reduce the internal temperature of the crab to between 1° and 10° C.;
de-backing the cooled crab in order for only the body meat portion and attached swimming legs to remain; and
sectioning the swimming legs in order to produce a separate first part of the body meat portion attached to one of the swimming legs and a separate second part of the body meat portion attached to the other of the swimming legs;
wherein the attached body meat portion first part and swimming leg comprises a first ready-to-eat de-backed crab leg and the attached body meat portion second part and swimming leg comprises a second ready-to-eat de-backed crab leg.

2. The method of claim 1, wherein the cooking step comprises steam cooking the crab from between about 20 and 35 minutes.

3. The method of claim 1, wherein said temperature reducing step includes air cooling the cooked crab followed by and cooling the air cooled crab at a temperature of between 1° and 4° C.

4. The method of claim 1, wherein the de-backing step includes removing parts of the crab selected from the group consisting of carapaces, gills, fat and shell.

5. The method of claim 1, further including the step of manually trimming the body meat portion parts of each of the de-backed crab legs.

6. The method of claim 1, further including storing each de-backed crab leg at a temperature of between about −2° C. and 2° C.

7. The method of claim 1, wherein the swimming leg of each de-backed crab leg is scored.

8. The method of claim 1, wherein each de-backed crab leg is hermetically sealed in a can.

9. The method of claim 8, wherein each hermetically sealed crab leg is pasteurized by heating followed by submergence in an ice bath.
